(19) United States
(12) Patent Application Publication
(10) Pub. No.: US 2008/0196496 A1
(43) Pub. Date: Aug. 21, 2008

(54) Wheel Balancing Method and Apparatus

(75) Inventors: Joseph L. Jablonski, Linden, MI (US); Gene P. Emmerich, Commerce Township, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/676,518

(22) Filed: Feb. 20, 2007

(51) Int. Cl. G01M 1/16

(52) U.S. Cl. 73/462

(57) ABSTRACT

A method for balancing a wheel and tire assembly includes providing a wheel and tire assembly characterized by a rotational imbalance, and applying a fluid to the wheel and tire assembly thereby to correct the rotational imbalance. The use of a liquid to correct a rotational imbalance facilitates the automation of a balancing operation. Accordingly, another method is provided that includes determining a quantity of mass to be applied to a wheel and tire assembly to correct a rotational imbalance, and commanding an apparatus to dispense an amount of a fluid having the quantity of mass to be dispensed from a nozzle. A corresponding apparatus is also provided.

### TECHNICAL FIELD

This invention relates to methods of balancing wheel and tire assemblies and apparatuses therefor.

### BACKGROUND OF THE INVENTION

Rotational imbalance in a wheel and tire assembly may cause undesirable vibrations during rotation of the assembly. Accordingly, when a tire is mounted to a wheel, the wheel and tire assembly typically undergoes a balancing operation. The balancing operation typically includes determining an amount of corrective mass that is mounted to an appropriate location on the wheel and tire assembly to correct the rotational imbalance. The prior art includes wheel balancers that determine an appropriate corrective mass and that communicate the corrective mass to an assembly line worker.

The corrective mass added to a wheel and tire assembly is typically a solid metal weight, often comprised of lead, that is manually selected from an inventory and mechanically or adhesively fastened to the wheel by the assembly line worker. Since the amount of imbalance varies from assembly to assembly, and therefore the amount of corrective mass varies from assembly to assembly, balancing operations are typically provided with an inventory of weights having a plurality of different masses. For example, the inventory of weights may include weights having masses in discrete multiples of 0.25 ounces.

If the balancing operation involves balancing wheel and tire assemblies of different colors, then the inventory of weights may also include weights of various colors so that an operator can select a weight that corresponds to the color of a particular wheel for aesthetic purposes. If the balancing operation involves balancing wheel and tire assemblies of different diameters, then the inventory of weights may also include weights of various curvatures. Accordingly, the inventory of weights in a tire balancing operation may require a multitude of different parts.

### SUMMARY OF THE INVENTION

A method includes providing a wheel and tire assembly characterized by a rotational imbalance, and applying a fluid to the wheel and tire assembly thereby to correct the rotational imbalance. The method improves upon the prior art because a fluid can be applied to a wheel and tire assembly in any amount, thereby eliminating the need for an inventory having weights of various masses. The method also provides more accurate wheel and tire balancing compared to the prior art because the amount of fluid applied to the wheel and tire can be substantially exactly the corrective mass, rather than merely the mass of the solid weight (or combination of solid weights) in an inventory that most closely approximates the corrective mass. Applying fluid to a wheel and tire assembly, compared to applying fluid only to the wheel prior to mounting the tire thereto and subsequently balancing the resulting wheel and tire assembly, reduces the number of steps required to balance the wheel and tire assembly and may also reduce the total amount of corrective weight added to the wheel.

The application of a fluid to a wheel and tire assembly enables automation of a balancing operation. Accordingly, a method is also provided that includes determining a quantity of mass and a location on a wheel and tire assembly at which to place the quantity mass to correct a rotational imbalance, and commanding an apparatus to dispense from at least one nozzle an amount of a fluid having the mass. The method provided eliminates the manual step of finding and retreiving a weight from an inventory and manually applying the weight to the wheel and tire assembly, thereby improving productivity.

A corresponding system for assembling and balancing a wheel and tire assembly is provided. The system includes a tire mounting station configured to mount the tire to the wheel thereby to create a wheel and tire assembly characterized by rotational imbalance. The system also includes a balance testing apparatus and a conveyor system configured to transport the wheel and tire assembly from the tire mounting station to the balance testing apparatus. A balance correction apparatus is configured to selectively dispense a fluid. A controller is operatively connected to the balance testing apparatus, and is configured to determine a quantity of mass and at least one location on the wheel and tire assembly at which to place the quantity of mass to correct the rotational imbalance. The controller is also configured to command the balance correction apparatus to dispense an amount of fluid having the quantity of mass.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view of a wheel and tire assembly;

FIG. 2 is a schematic sectional view of the wheel and tire assembly of FIG. 1;

FIG. 3 is a schematic side view of a balancing apparatus;

FIG. 4 is a flow chart depiction of a method for balancing a wheel and tire assembly; and

FIG. 5 is a schematic depiction of a wheel and tire assembly system.

### DESCRIPTION OF THE PREFERRED EMBODIMENTS

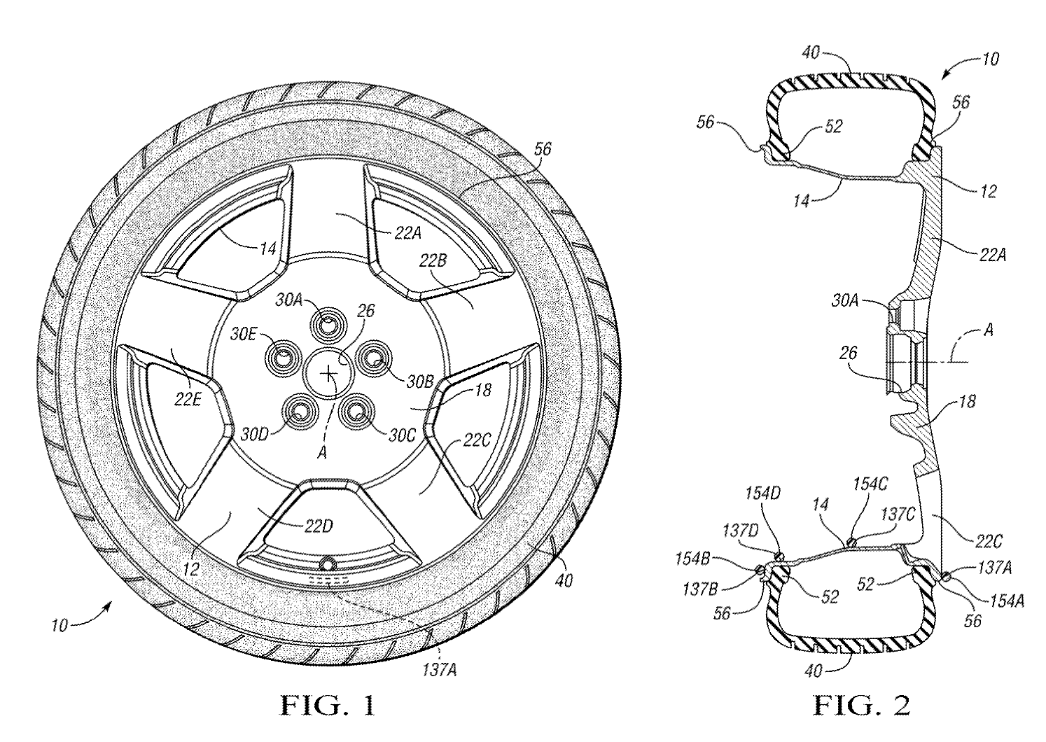

Referring to FIGS. 1 and 2, a wheel and tire assembly 10 is schematically depicted. The wheel and tire assembly 10 includes a vehicle wheel 12. The wheel 12 includes a rim 14 and a hub 18. The hub 18 and the rim 14 are interconnected, such as by a plurality of spokes 22A-E, as understood by those skilled in the art. In the embodiment depicted, the wheel 12 defines a center aperture 26 at the wheel's axis of rotation A, and a plurality of evenly-spaced lug holes 30A-E for attachment of the wheel 12 to a vehicle (not shown) as understood by those skilled in the art. The lug holes 30A-E are arranged in a circle that has its center on the axis of rotation. The wheel and tire assembly 10 includes a tire 40 that is mounted to the wheel 12. The beads 52 of the tire 40 are seated against the rim 14 between the inboard and outboard rim flanges 56 such that the tire 40 circumscribes the rim 14 of the wheel 12. The tire 40 is inflated after being mounted to the wheel 12. The wheel and tire assembly 10 is characterized by a rotational imbalance. It should be noted that the rotational imbalance may, within the scope of the claimed invention, include a static imbalance or a dynamic imbalance.

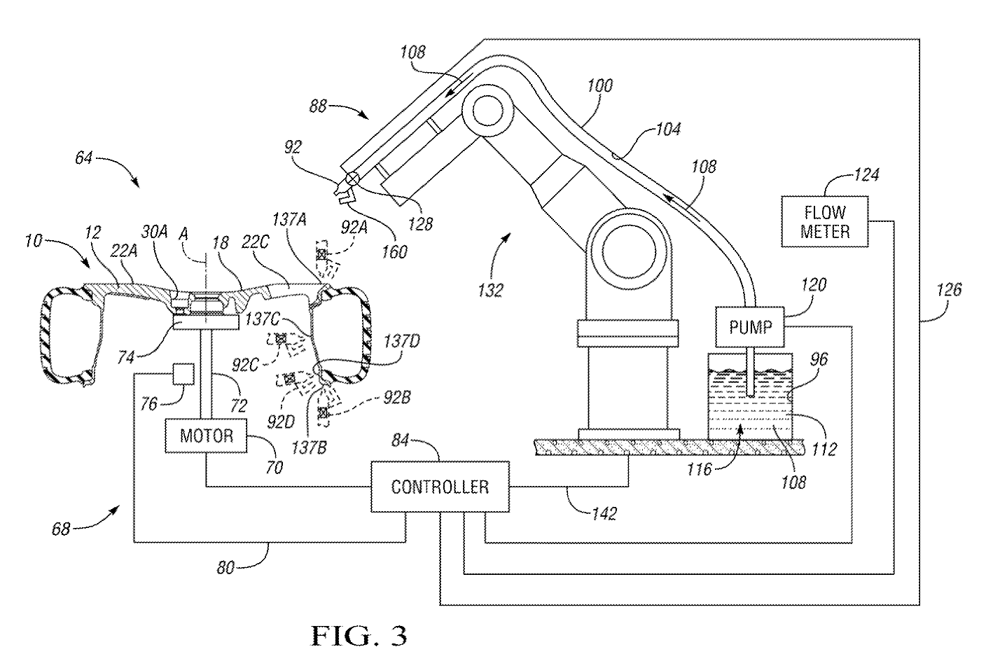

Referring to FIG. 3, a balancing apparatus 64 is schematically depicted. The balancing apparatus includes a balance testing apparatus 68. In the embodiment depicted, the balance testing apparatus 68 includes an electric motor 70 operatively connected to, and configured to selectively rotate, a spindle or shaft 72. The wheel and tire assembly 10 is substantially rigidly mountable to the end of the shaft 72, as shown in FIG. 5, for rotation therewith. The shaft 72 may include a hub 74 to stabilize the tire and wheel assembly 10. Thus, during operation of the balance testing apparatus 68, the wheel and tire assembly 10 is rotated about its axis A by the motor 70 via the shaft 72. When the wheel and tire assembly 10 is rotated, the rotational imbalance produces various effects such as vibrations and forces, which are transmitted to the shaft 72.

The balance testing apparatus 68 in the embodiment depicted includes various sensors or transducers 76 that measure the angular velocity of the shaft 72 (and therefore the angular velocity of the wheel and tire assembly 10), the rotational position of the shaft 72 (and therefore the rotational position of the wheel and tire assembly 10) and the vibrations and forces transmitted to shaft 72 from the wheel and tire assembly 10. The sensors 76 transmit sensor signals 80 to a controller 84. The sensor signals 80 are indicative of the angular velocity of the shaft 72, the rotational position of the shaft 72, and the vibrations and forces caused by the rotational imbalance. A “controller” may include one or more controllers that cooperate together. The controller 84 is preferably a digital controller, although any controller configuration may be used within the scope of the claimed invention.

It should be noted that the balance testing apparatus 68 depicted is a dynamic balancer; however, and within the scope of the claimed invention, the balance testing apparatus 68 may be a static balancer.

The balancing apparatus 64 also includes a balance correction apparatus 88 that is configured to apply a corrective mass to the wheel and tire assembly 10 to correct the rotational imbalance. In the context of the present invention, a rotational imbalace is corrected when the rotational imbalance is reduced to zero or is brought within a predetermined range of acceptable imbalance. The balance correction apparatus 88 includes a nozzle 92 that is in fluid communication with a reservoir 96, which may, for example, be a barrel, via a conduit 100 defining a fluid passageway 104.

The reservoir 96 contains a fluid 108. In the context of the claimed invention, a “fluid” includes any material that tends to, or is capable of, flowing, including semifluids. In an exemplary embodiment, the fluid 108 includes a liquid adhesive 112 having solid particles 116 interspersed therein to increase the density of the fluid 108, preferably such that the fluid 108 has a specific gravity the same as, or higher than, lead. The solid particles 116 are preferably comprised of a powdered metal such as lead, tungsten, hafnium, osmium, etc.

A pump 120 is configured to pressurize the fluid 108 so that the fluid 108 flows from the reservoir 96 to the nozzle 92 via the passageway 104. The controller 84 is operatively connected to the pump 120 to control the operation thereof. A flow meter 124 is configured to measure the mass or volume flow rate of the fluid 108 through the passageway 104, and accordingly, the mass or volume flow rate of the fluid 108 to the nozzle 92, and to transmit a sensor signal 126 indicative of the flow rate to the controller 84. A valve 128 adjacent the nozzle 92 causes selectively variable restriction in the nozzle 92 to regulate the flow of fluid 108 dispensed from the nozzle 92. The controller 84 is operatively connected to the valve 128 to control the operation thereof.

In the embodiment depicted, at least one actuator, such as a robotic arm 132 to which the nozzle 92 is operatively connected, is controllable by the controller 84 to vary the position of the nozzle 92 with respect to the wheel and tire assembly 10.

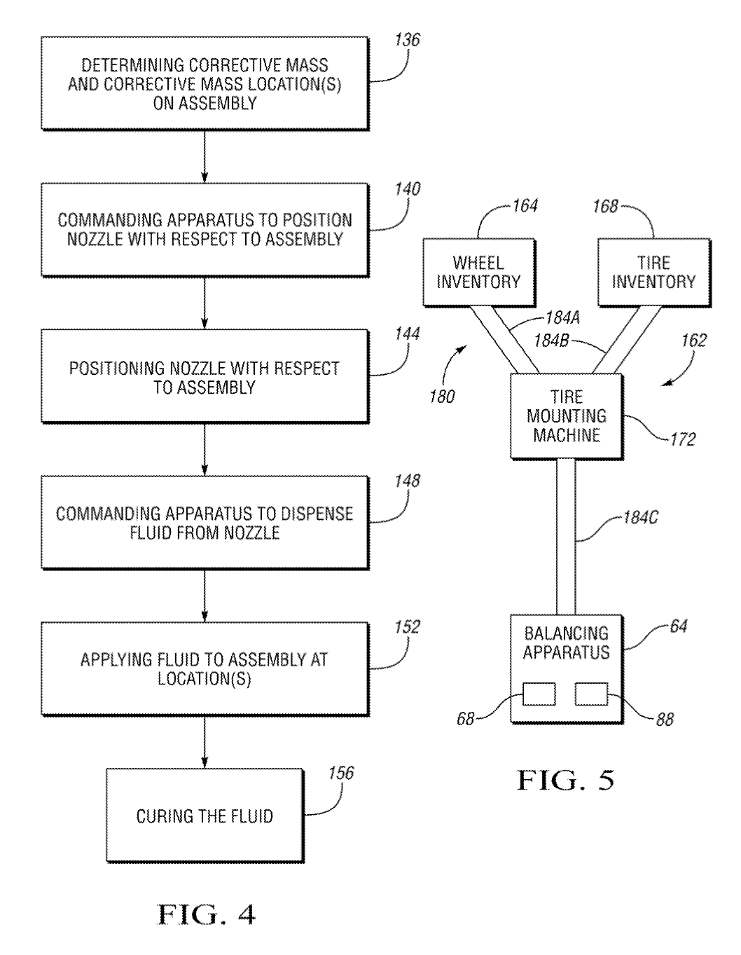

FIG. 4 is a flow chart depiction of a method of balancing the wheel and tire assembly 10 of FIGS. 1 and 2, and represents an exemplary control logic for the controller 84. Referring to FIGS. 3 and 4, the method includes determining a quantity of mass and one or more locations on the wheel and tire assembly 10 at which to place the quantity of mass to correct the rotational imbalance (step 136). In the embodiment depicted, the controller 84 performs step 136 by causing the motor 70 to rotate the wheel and tire assembly 10 about its axis A via the shaft 72 thereby to generate the effects of rotational imbalance. The sensors 76 transmit signals 80 indicative of the effects of the rotational imbalance to the controller 84.

The controller 84 is programmed to process the sensor signals 80 according to a predetermined algorithm and thereby determine a quantity of corrective mass and one or more locations on the wheel and tire assembly 10 at which to place the quantity of corrective mass to correct the rotational imbalance, as understood by those skilled in the art. The controller 84 may also use other data, in addition to the sensor signals 80, to determine a quantity of mass and a location on the wheel and tire assembly 10, such as the diameter of the wheel, which may be measured by other sensors (not shown) or input manually by an operator.

For example, the controller 84 may determine at step 136 that a quantity of mass is to be placed at adjacent the rim 14 between spokes 22C and 22D (shown in FIG. 1) to correct the rotational imbalance. The quantity of mass to be placed between spokes 22C and 22D may be applied at one or more non-contiguous locations between spokes 22C and 22D, such as locations 137A (shown in FIGS. 1 and 2) and locations 137B, 137C (shown in FIG. 1). Location 137A is a region on the surface of the outboard rim flange 56. Location 137B is a region on the surface of the inboard rim flange 56. Locations 137C and 137D are on the radially inner surface of the rim 14. Locations 137B, 137C, and 137D are advantageous in that they are not normally visible when the wheel and tire assembly 10 is attached to a vehicle (not shown).

The method may also include commanding an actuator (step 140) to position the nozzle 92 with respect to the wheel and tire assembly 10 such that fluid dispensed from the nozzle 92 flows onto the wheel and tire assembly 10 at the location or locations determined at step 136. In the embodiment depicted, the controller 84 transmits signals 142 to the robotic arm 132, thereby commanding the robotic arm 132 to position the nozzle 92 with respect to the wheel and tire assembly 10 such that fluid dispensed from the nozzle 92 flows onto the wheel and tire assembly 10 at the location or locations determined at step 136.

Thus, for example, if the one or more locations on the tire and wheel assembly determined at step 136 includes location 137A, then the controller 84 will command the robotic arm 132 to move the nozzle to the position shown at 92A so that fluid 108 from the nozzle flows onto the wheel and tire assembly at location 137A at step 140. If the one or more locations on the tire and wheel assembly determined at step 136 includes location 137B, then the controller 84 will command the robotic arm 132 to move the nozzle to the position shown at 92B so that fluid 108 from the nozzle flows onto the wheel and tire assembly at location 137B at step 140. Similarly, if the one or more locations on the tire and wheel assembly determined at step 136 include location 137C, then the controller 84 will command the robotic arm 132 to move the nozzle to the position shown at 92C so that fluid 108 from the nozzle flows onto the wheel and tire assembly at location 137C at step 140. If the one or more locations on the tire and wheel assembly determined at step 136 include location 137D, then the controller 84 will command the robotic arm 132 to move the nozzle to the position shown at 92D so that fluid 108 from the nozzle flows onto the wheel and tire assembly at location 137D at step 140

It should also be noted that commanding an actuator to position the nozzle 92 with respect to, or relative to, the wheel and tire assembly 10 may, within the scope of the claimed invention, include moving the wheel and tire assembly 10 with respect to the nozzle 92. Thus, for example, step 140 may include commanding the motor 70 to rotate the wheel and tire assembly 10 so that the location at which mass is to be added is proximate to the robotic arm 132. In an alternative embodiment (not shown) of the balance correction apparatus, and within the scope of the claimed invention, one or more nozzles in fluid communication with a pump may be stationary. For example, one or more nozzles may be fixed in any of the the nozzle positions indicated at 92A, 92B, 92C, 92D. In such an embodiment, the actuator employed to position the nozzle or nozzles with respect to the wheel and tire assembly 10 may, for example, be the motor 70, which is commanded by the controller 84 at step 140 to rotate the wheel and tire assembly 10 so that it is positioned with respect to the nozzle or nozzles such that fluid from the nozzle or nozzles flows onto the wheel and tire assembly 10 at the location or locations determined at step 136.

The method may also include positioning the nozzle 92 with respect to the wheel and tire assembly 10 (step 144) such that fluid from the nozzle 92 flows onto the wheel and tire assembly 10 at the location or locations determined at step 136. In the embodiment depicted, the robotic arm 132 positions the nozzle 92 as commanded by the controller 84 at step 140. It should be noted that the robotic arm 132 is depicted schematically in FIG. 3; those skilled in the art will understand the dimensions of a robotic arm necessary to position the nozzle 92 as desired relative to the wheel and tire assembly 10. In the alternative embodiment in which the nozzle or nozzles are stationary, the motor 70 positions the nozzle or nozzles with respect to the wheel and tire assembly 10 at step 144 by rotating the wheel and tire assembly 10 in response to a command transmitted by the controller 84 at step 140.

The method further includes commanding (step 148) the apparatus 88 to dispense from the nozzle 92 an amount of the fluid 108 having the quantity of mass determined at step 136. In the embodiment depicted, the controller 84 may command the apparatus 88 to dispense from the nozzle 92 an amount of the fluid 108 having the quantity of mass determined at step 136 by controlling the pump 120 and the valve 128. The flow meter 124 provides feedback to the controller 84 so that the controller 84 can determine how much fluid has been dispensed from the nozzle 92 and, accordingly, when to close the valve 128 and, optionally, stop the pump 120.

The method may further include applying fluid (step 152) to the wheel and tire assembly 10 at the location or locations determined at step 136. In the embodiment depicted, the pump 120 conveys fluid 108 from the reservoir 96 to the nozzle 92. The valve 128 responds to commands transmitted by the controller 84 at step 148 to open sufficiently and for a sufficient duration to allow fluid 108 to flow from the nozzle 92 onto the wheel and tire assembly 10. Preferably, the nozzle 92 moves with respect to the wheel and tire assembly 10, or vice versa, as the fluid flows from the nozzle 92 onto the wheel and tire assembly 10 so that the fluid 108 is distributed over the location or locations determined at step 136 to form a bead at each location, such as beads 154A, 154B, 154C, and 154D shown in FIG. 2, at locations 137A, 137B, 137C, 137D, respectively.

If the adhesive 112 of fluid 108 requires curing in order to solidify, then the method may include curing the fluid 108 at step 156. A heating device 160 is mounted to the robotic arm 132 adjacent the nozzle 92 to direct heat to the fluid 108 after it is applied to the wheel and tire assembly to cure the fluid 108. Those skilled in the art will recognize that the curing technique may vary depending on the composition and characteristics of the adhesive employed. Accordingly, a variety of methods may be used to cure an adhesive within the scope of the claimed invention, such as exposing the adhesive to ultraviolet light with a laser, using a curing agent, etc.

It should be noted that, although the method of FIG. 4 is described in relation to controller 84, the method, or any steps thereof, may be performed manually within the scope of the claimed invention. It should also be noted that other fluids and other balance correction apparatuses for applying fluid may be employed within the scope of the claimed invention. For example, molten solder may be applied to a wheel and tire assembly 10 to correct a rotational imbalance within the scope of the claimed invention.

Referring to FIG. 5, wherein like reference numbers refer to like components from FIGS. 1-4, a wheel and tire assembly system 162 for high-volume production of wheel and tire assemblies is schematically depicted. The system 162 includes a wheel inventory 164 containing a plurality of wheels. The system 162 also includes a tire inventory 168 containing a plurality of tires. A tire mounting station 172 is configured to receive tires and wheels from the inventories 164, 168, and to mount the tires to the wheels. Those skilled in the art will recognize and understand the operation of an automatic tire mounting station. An exemplary tire mounting station and machine is described in U.S. Pat. No. 4,621,671, issued Nov. 11, 1986 to Kane et al.

The system 162 also includes the balancing apparatus 64, which includes the balance testing apparatus 68 and the balance correction apparatus 88. A conveyor system 180 includes a plurality of conveyors 184A, 184B, 184C. Conveyor 1 84A conveys wheels from the wheel inventory 164 to the tire mounting station 172, conveyor 184B conveys tires from the tire inventory 168 to the tire mounting station 172, and conveyor 184C conveys wheel and tire assemblies from the tire mounting station 172 to the balancing apparatus 64. A conveyor system that is configured to transport a wheel and tire assembly from the tire mounting station to the balance testing apparatus may include multiple conveyors within the scope of the claimed invention, and may or may not convey a wheel and tire assembly directly from the tire mounting station to the balancing apparatus. For example, and within the scope of the claimed invention, a conveyor system that is configured to transport a wheel and tire assembly from the tire mounting station to the balancing apparatus may include a first conveyor to transport a wheel and tire assembly from the tire mounting station to a tire inflation station (not shown), and a second conveyor to transport the wheel and tire assembly from the inflation station to the balancing apparatus 64.

While the best modes for carrying out the invention have been described in detail, those familiar with the art to which this invention relates will recognize various alternative designs and embodiments for practicing the invention within the scope of the appended claims.

1. A method comprising:
providing a wheel and tire assembly characterized by a rotational imbalance; and
applying a fluid to the wheel and tire assembly thereby to correct the 5 rotational imbalance.

2. The method of claim 1, wherein the fluid includes a liquid and solid particles interspersed within the liquid.

3. The method of claim 2, wherein the solid particles are metal.

4. The method of claim 1, wherein the fluid is an adhesive; and wherein the method further comprises curing the adhesive.

5. The method of claim 1, further comprising mounting a tire to a wheel thereby to create the wheel and tire assembly.

6. A method of balancing a wheel and tire assembly characterized by a rotational imbalance, the method comprising:
determining a quantity of mass and at least one location on the wheel and tire assembly at which to place the quantity of mass to correct the rotational imbalance; and
commanding an apparatus having at least one nozzle to dispense an amount of a fluid having the quantity of mass from said at least one nozzle.

7. The method of claim 6, further comprising, subsequent to said commanding an apparatus having at least one nozzle to dispense an amount of fluid having the quanity of mass from said at least one nozzle, dispensing the fluid from said at least one nozzle such that the fluid flows onto the wheel and tire assembly.

8. The method of claim 7, further comprising commanding the apparatus to position said at least one nozzle relative to the wheel and tire assembly such that the fluid flows onto the wheel and tire assembly at said at least one location on the wheel and tire assembly.

9. The method of claim 7, wherein the fluid includes an adhesive; and wherein the method further comprises curing the adhesive.

10. A system for assembling a wheel and a tire comprising:
a tire mounting station configured to mount the tire to the wheel thereby to create a wheel and tire assembly characterized by rotational imbalance;
a balance testing apparatus;
a conveyor system configured to transport the wheel and tire assembly from the tire mounting station to the balance testing apparatus;
a balance correction apparatus configured to selectively dispense a fluid; and
at least one controller being operatively connected to said balance testing apparatus, being configured to determine a quantity of mass and at least one location on the wheel and tire assembly at which to place the quantity of mass to correct the rotational imbalance, and being configured to command the balance correction apparatus to dispense an amount of fluid having the quantity of mass.

11. The system of claim 10, wherein said balance testing apparatus includes a motor configured to selectively rotate the wheel and tire assembly to produce effects caused by the rotational imbalance; and
at least one sensor configured to monitor the effects and to transmit signals indicative of the effects;
wherein said at least one controller is operatively connected to said at least one sensor to receive said signals.

12. The apparatus of claim 10, wherein said balance correction apparatus includes at least one nozzle configured to dispense the fluid, and at least one pump in fluid communication with said at least one nozzle to deliver the fluid to said at least one nozzle.

13. The apparatus of claim 12, further comprising at least one actuator configured to selectively alter the relative position of said at least one nozzle with respect to the wheel and tire assembly; and wherein the controller is operatively connected to said at least one actuator and configured to command said at least one actuator to alter the relative position of said at least one nozzle with respect to the wheel and tire assembly such that fluid dispensed from said at least one nozzle flows onto the wheel and tire assembly at said at least one location on the wheel and tire assembly.

14. The apparatus of claim 13, wherein said at least one actuator includes a robot to which the nozzle is operatively connected.

15. The apparatus of claim 12, wherein the balance correction apparatus further includes a flow meter configured to monitor the amount of fluid delivered by the pump to said at least one nozzle and to transmit flow meter signals indicate thereof to said at least one controller.

16. The apparatus of claim 12, further comprising a valve being configured to selectively regulate fluid flow from said at least one nozzle; said at least one controller being operatively connected to the valve to selectively control the valve.
